(19) United States
(12) Patent Application Publication
(10) Pub. No.: US 2008/0001872 A1
(43) Pub. Date: Jan. 3, 2008

(54) Liquid crystal display device

(75) Inventor: Hirotoshi Abe, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/645,717

(22) Filed: Dec. 27, 2006

(30) Foreign Application Priority Data
Jun. 29, 2006 (JP) 2006-180267

(51) Int. Cl. G09G 3/36

(52) U.S. Cl. 345/87

(57) ABSTRACT

A liquid crystal display device (1) according to the invention adds a former image and a latter image which are continuous. When an image corresponding to a received video signal is a still image, an effect of noise reduction is provided by multiplying the former image by a positive coefficient. On the other hand, when an image corresponding to the received video signal is a moving image, a difference between the former image and the latter image is obtained by multiplying the former image by a negative coefficient, thereby providing an effect of overdrive.

The present application is based on Japanese application No. 2006-180267, the entire contents of which are incorporated herein by reference.

### BACKGROUND

1. Field

One embodiment of the invention relates to a liquid crystal display device, and more particularly to a liquid crystal display device which is capable of exhibiting an effect of overdrive in a noise reduction circuit.

2. Description of the Related Art

In recent years, scale-up of image display apparatuses such as a television has progressed, and thus general consumers have been concerned about animage quality as well about which they have not been nervous so much for image display apparatuses each having a conventional size.

When a still image is displayed, a flicker occurs in an image in which any flicker should not essentially occur due to addition of a noise to a video signal in some cases. In order to dissolve such a state, there has been developed an image display apparatus which has a noise reduction (NR) circuit incorporated therein, and thus which is capable of suppressing a flicker occurring in an image due to a noise. This sort of image display apparatus, for example, is disclosed in the Japanese Patent Kokai Nos. 2004-246118 and 11-69202.

In addition, when a moving image is displayed on a liquid crystal display device, a so-called “moving image blur” may occur due to the poor response of a liquid crystal. Then, a liquid crystal display device having an overdrive (OD) circuit incorporated therein has been developed by utilizing one of the techniques for causing the moving image blur to hardly occur by improving the response of the liquid crystal. This liquid crystal display device, for example, is disclosed in the Japanese Patent Kokai No. 2003-143556.

As described above, the NR circuit is devised for the purpose of improving the image quality of the still image, while the OD circuit is devised for the purpose of improving the image quality of the moving image. Thus, both the purposes are different from each other at all. However, it is desirable to incorporate both the NR circuit and the OD circuit in the liquid crystal display device because both the still image and the moving image are intended to be displayed on the liquid crystal display device.

In the conventional liquid crystal display device, however, the incorporation of both the NR circuit and the OD circuit results in the increased cost and an obstacle to space saving in the electronic apparatuses of late years.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiment of the invention and not to limit the scope of the invention.

FIG. 1 is an exemplary block diagram showing a configuration of a liquid crystal display device according to an example of a related art;

FIG. 2A is an exemplary block diagram showing a configuration of a liquid crystal display device according to an embodiment of the invention;

FIG. 2B is an exemplary block diagram showing a configuration of an add circuit according to an embodiment of the invention;

FIG. 2C is an exemplary block diagram showing a configuration of a motion detecting circuit according to an embodiment of the invention;

FIGS. 3A to 3C are respectively exemplary graphical representations showing operation for NR processing executed in the liquid crystal display device according to the embodiment of the invention;

FIGS. 4A to 4E are respectively exemplary graphical representations showing operation for OD processing executed in the liquid crystal display device according to the embodiment of the invention; and

FIG. 5 is an exemplary flow chart showing image processing executed in the liquid crystal display device according to the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a liquid crystal display device, including: a receiving portion for receiving a video signal; a motion detecting portion for detecting whether an image corresponding to the video signal is a still image or a moving image; and a signal adding portion for, when the motion detecting portion detects that the image is the still image, operating as a noise reduction circuit for the image, and when the motion detecting portion detects that the image is the moving image, operating as an overdrive circuit for the image.

In addition, according to the embodiment of the invention, there is provided a liquid crystal display device, including: a receiving portion for receiving a video signal; a motion detecting portion for detecting whether an image corresponding to the video signal is a still image or a moving image; and a signal adding portion for, when the motion detecting portion detects that the image is the still image, adding image signals corresponding to continuous frames contained in the image, and when the motion detecting portion detects that the image is the moving image, adding a difference between image signals corresponding to the continuous frames contained in the image to the video signal corresponding to the latter frame of the continuous frames.

According to the embodiment of the invention, a sum of the former frame and the latter frame is obtained when the image is detected as the still image, and a difference between the former frame and the latter frame is obtained when the image is detected as the moving image, which results in that one circuit can operate for both the functions of the NR circuit and the OD circuit. As a result, it is possible to realize the low cost promotion and the space saving for the liquid crystal display device.

In addition, according to the embodiment of the invention, there is provided a liquid crystal display device, including: a receiving portion for receiving a video signal; a motion detecting portion for detecting whether an image corresponding to the video signal is a still image or a moving image; a coefficient selecting portion for, when the motion detecting portion detects that the image is the still image, selecting a positive coefficient, and when the motion detecting portion detects that the image is the moving image, selecting a negative coefficient; a coefficient multiplying portion for multiplying the former image signal of the image signals corresponding to continuous frames contained in the image by the coefficient selected by the coefficient selecting portion; and a signal adding portion for adding the image signal obtained from the coefficient selecting portion to the former image signal of the image signals corresponding to the continuous frames contained in the image.

According to the embodiment of the invention, when the sum of the former frame and the latter frame is obtained, the former video signal is multiplied by the positive coefficient in the case of the still image, and the former video signal is multiplied by the negative coefficient in the case of the moving image to obtain the sum and the difference, respectively. As a result, it is possible to realize the low cost promotion and the space saving for the liquid crystal display device since one circuit can be given both the functions of the NR circuit and the OD circuit.

According to the invention, it is possible to realize the low cost promotion and the space saving for the liquid crystal display device since one circuit can operate for both the functions of the noise reduction circuit and the overdrive circuit.

An embodiment of the invention will be described hereinafter with reference to the drawings.

### (Configuration of Liquid Crystal Display Device Including NR circuit and OD circuit)

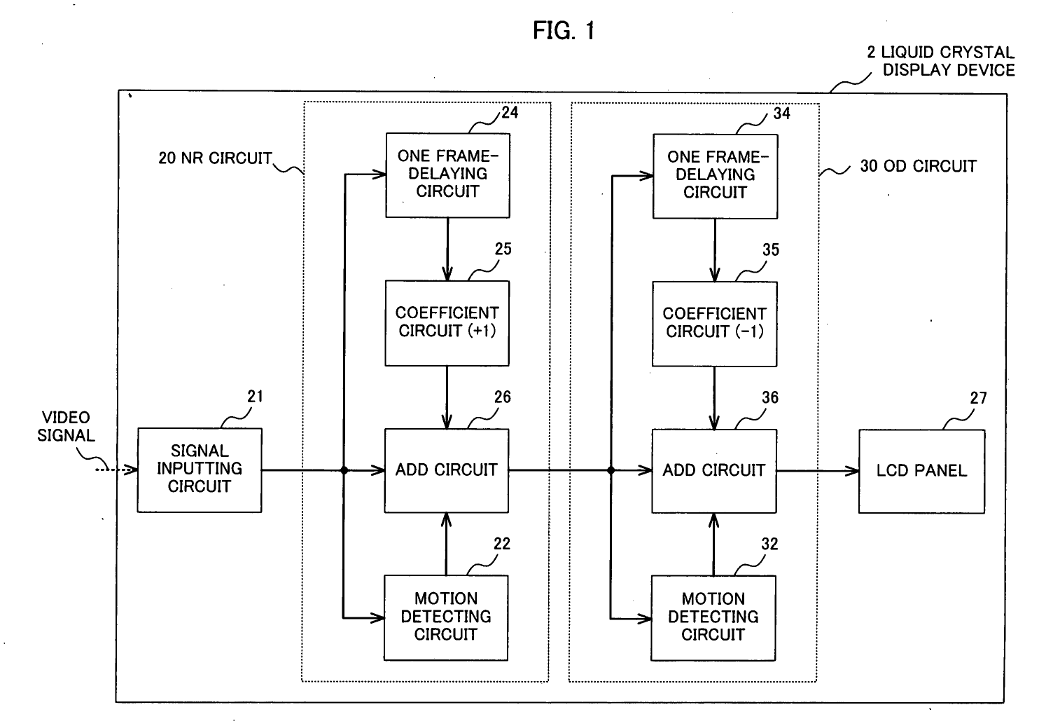

FIG. 1 is a block diagram showing a conventional example of a configuration of a liquid crystal display device having both an NR circuit and an OD circuit incorporated therein.

A liquid crystal display device 2 includes a signal inputting circuit 21, an NR circuit 20, an OD circuit 30, and an LCD panel 27. In addition, the NR circuit 20 includes a motion detecting circuit 22, a one frame-delaying circuit 24, a coefficient circuit 25, and an add circuit 26. Moreover, the OD circuit 30 includes a motion detecting circuit 32, a one frame-delaying circuit 34, a coefficient circuit 35, and an add circuit 36.

The signal inputting circuit 21 receives a video signal as its input in accordance with reception of a television broadcasting signal via an antenna or the like, transmission of a video signal from an external apparatus connected to the liquid crystal device 2 via an external terminal or the like, read of a video signal stored in a memory, or the like.

The NR circuit 20 removes a noise contained in a video signal. The motion detecting circuit 22 detects whether an image corresponding to a video signal is a still image or a moving image. The one frame-delaying circuit 24 temporarily stores therein a video signal to which an image of the last frame corresponds. The coefficient circuit 25 multiplies the video signal, to which the image corresponds, temporarily stored in the one frame-delaying circuit 24 by a positive coefficient. The add circuit 26 adds information on the last frame generated in the coefficient circuit 25 to each of frames of the video signal transmitted from the signal inputting circuit 21.

The OD circuit 30 improves the poor response of the liquid crystal of the LCD panel 27. The motion detecting circuit 32 detects whether an image corresponding to a video signal is a still image or a moving image. The one frame-delaying circuit 34 temporarily stores therein a video signal to which an image of the last frame corresponds. The coefficient circuit 35 multiplies the video signal, to which the image corresponds, temporarily stored in the one frame-delaying circuit 34 by a negative coefficient. The add circuit 36 adds information on the last frame generated in the coefficient circuit 35 to each of frames of the video signal transmitted from the signal inputting circuit 21.

The LCD panel 27 displays thereon an image corresponding to the video signal transmitted from the OD circuit 30.

According to the liquid crystal display device 2 as shown in FIG. 1, both the NR circuit 20 and the OD circuit 30 are incorporated therein, which results in that when the moving image is displayed as well as when the still image is displayed, it is possible for a user to appreciate the image having a high image quality.

### Configuration of Liquid Crystal Display Device According to Embodiment of the Invention

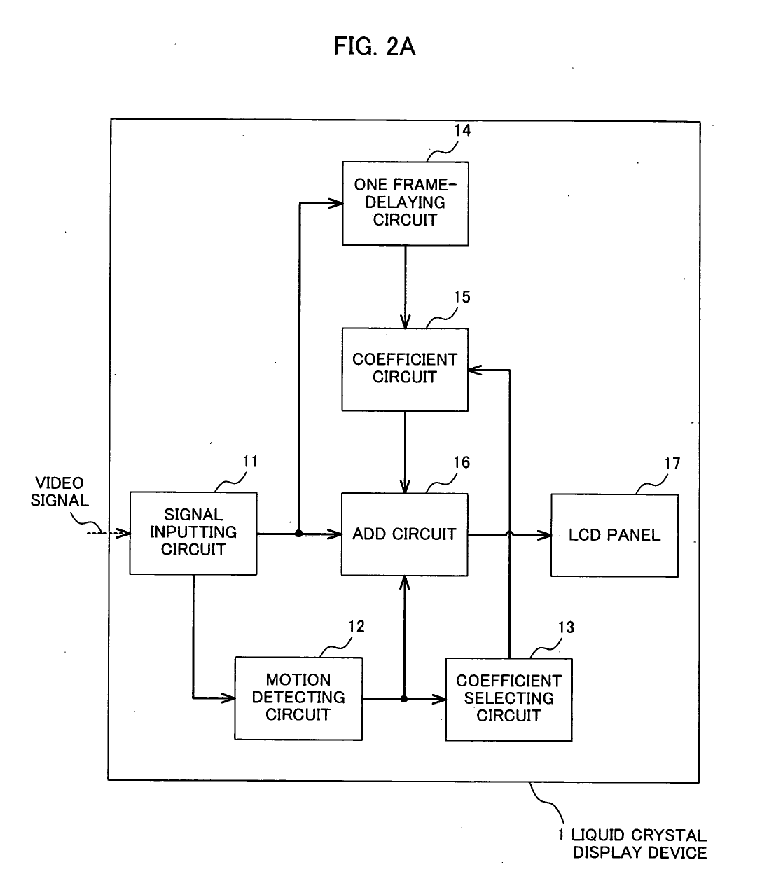

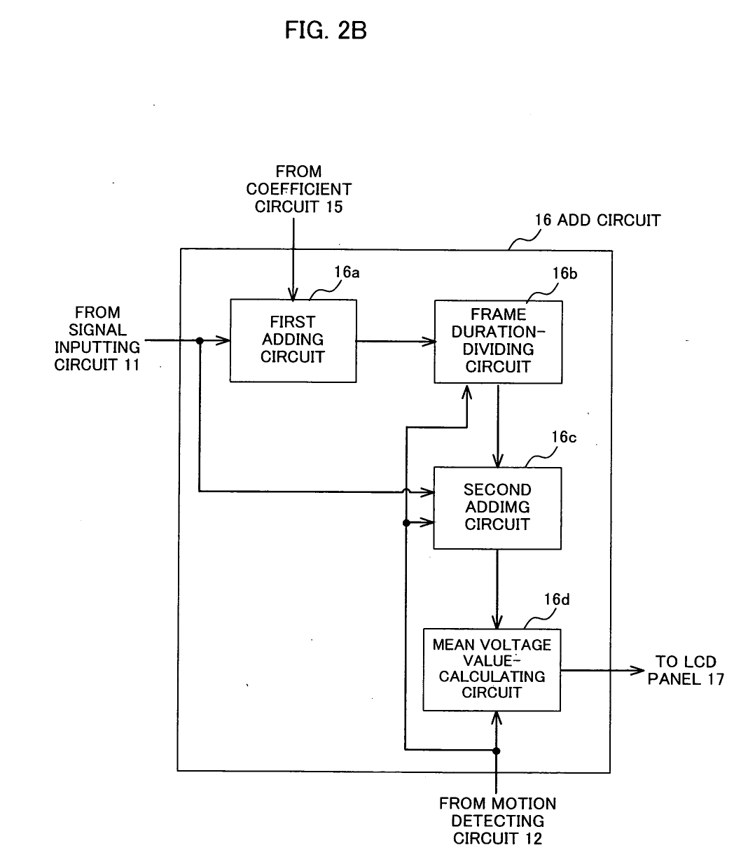

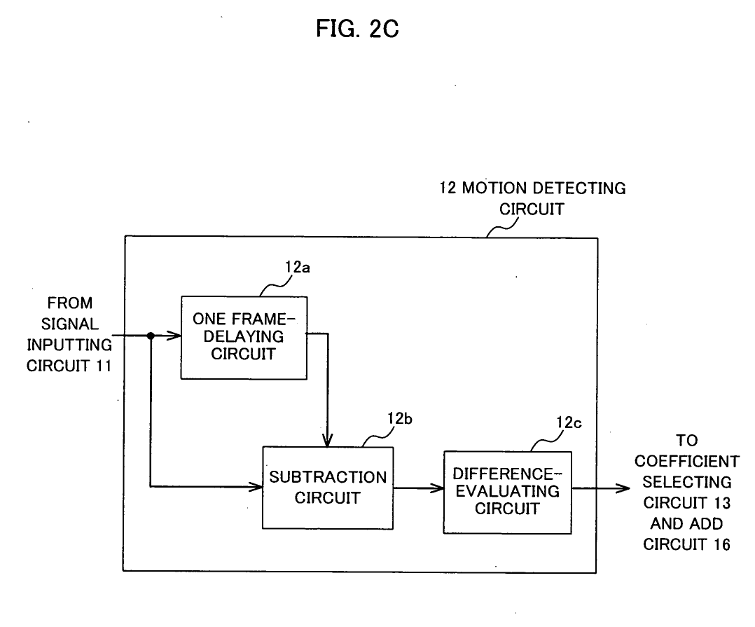

FIG. 2A is a block diagram showing an internal configuration of a liquid crystal display device according to an embodiment of the invention.

A liquid crystal display device 1 according to the embodiment of the invention includes a signal inputting circuit 11, a motion detecting circuit 12, a coefficient selecting circuit 13, a one frame-delaying circuit 14, a coefficient circuit 15, an add circuit 16, and an LCD panel 17.

The signal inputting circuit 11 receives a video signal as its input in accordance with reception of a television broadcasting signal via an antenna or the like, transmission of a video signal from an external apparatus connected to the liquid crystal display device 1 via an external terminal or the like, read of a video signal stored in a memory, or the like.

The motion detecting circuit 12 detects whether an image which corresponds to a video signal inputted to the signal inputting circuit 11 and which is intended to be displayed on the LCD panel 17 is a still image or a moving image. Specifically, the motion detecting circuit 12 judges whether the image corresponding to the video signal is the still image or the moving image by comparing two frames which are continuous in terms of time with each other.

The coefficient selecting circuit 13 selects a coefficient which is used in the coefficient circuit 15 which will be described later in accordance with the detection result obtained from the motion detecting circuit 12. Specifically, when the motion detecting circuit 12 judges that the image corresponding to the video signal is the still image, the coefficient selecting circuit 13 selects “+1” as the corresponding coefficient, and when the motion detecting circuit 12 judges that the image corresponding to the video signal is the moving image, the coefficient selecting circuit 13 selects “−1” as the corresponding coefficient.

The one frame-delaying circuit 14 temporarily stores therein the image signal of the image of the last frame used in the image processing executed in the add circuit 16 which will be described later. Here, the image signals constitute the video signal and correspond to the frames, respectively.

The coefficient circuit 15 multiplies the image signal of the image of the last frame temporarily stored in the one frame-delaying circuit 14 by the coefficient selected by the coefficient selecting circuit 13 to generate information which is to be added to the video signal in the add circuit 16.

The add circuit 16 adds the information on the last frame generated in the coefficient circuit 15 to each of the frames of the video signal transmitted from the signal inputting circuit 11 to generate the corrected video signal.

The LCD panel 17 displays thereon the image corresponding to the corrected video signal transmitted from the add circuit 16.

FIG. 2B is an exemplary block diagram showing a configuration of the add circuit 16 according to the embodiment of the invention.

The add circuit 16 includes a first adding circuit 16a, a frame duration-dividing circuit 16b, a second adding circuit 16c, and a mean voltage value-calculating circuit. The first adding circuit 16a adds a video signal from the signal inputting circuit 11 to a video signal from the coefficient circuit 15. The frame duration-dividing circuit 16b divides a duration of a signal output from the first adding circuit 16a by a predetermined constant n which is, for instance, three or four. The second adding circuit 16c adds a signal output from the frame duration-dividing circuit 16b to a video signal from the signal inputting circuit 11. The mean voltage value-calculating circuit 16d obtains a mean voltage value of the signal output from the frame duration-dividing circuit 16b and a video signal from the signal inputting circuit 11 by dividing a signal from the second adding circuit 16c by two.

The frame duration-dividing circuit 16b and the second adding circuit 16c execute each function when the motion detecting circuit 12 detects an image which corresponds to the video signal is a moving image. The mean voltage value-calculating circuit 16d execute its function when the motion detecting circuit 12 detects an image which corresponds to the video signal is a still image.

FIG. 2C is an exemplary block diagram showing a configuration of a motion detecting circuit 12 according to the embodiment of the invention.

The motion detecting circuit 12 includes an one frame-delaying circuit 12a, a subtraction circuit 12b, and a difference-evaluating circuit 12c. The one frame-delaying circuit 12a delays a frame of the video signal by one frame period. The subtraction circuit 12b obtains the difference by subtracting the frame delayed in the one frame-delaying circuit 12a from a latter frame of the video signal. The difference-evaluating circuit 12c evaluates a signal output from the subtraction circuit 12b by comparing the signal with a predetermined constant.

When the video signal is inputted to the signal inputting circuit 11, the video signal concerned is transmitted to each of the motion detecting circuit 12, the one frame-delaying circuit 14 and the add circuit 16. The motion detecting circuit 12 detects whether the image corresponding to the video signal concerned is a still image or a moving image in accordance with a difference between the continuous frames of the received video signal. Also, the coefficient selecting circuit 13 determines the suitable coefficient in accordance with the detection result obtained from the motion detecting circuit 12.

In addition, after each of the frames of the video signal transmitted to the one frame-delaying circuit 14 is multiplied by the suitable coefficient (+1 or −1) selected by the coefficient selecting circuit 13 in the coefficient circuit 15, the resulting frames are added to the latter frames, respectively, in the add circuit 15.

At this time, when the image corresponding to the video signal concerned is judged to be the still image, the coefficient selecting circuit 13 selects “+1” as the corresponding coefficient. As a result, the effect of the noise reduction is provided through the add processing executed in the add circuit 16.

On the other hand, when the image corresponding to the video signal concerned is judged to be the moving image, the coefficient selecting circuit 13 selects “−1” as the corresponding coefficient. Thus, in the add processing executed in the add circuit 16, after once a difference between the two continuous frames, that is, the former frame and the latter frame is obtained, the difference thus obtained is added to the latter frame. As a result, the effect of the overdrive is provided.

### [Noise Reduction Processing]

Next, a description will now be given with respect to noise reduction (ND) processing executed in the liquid crystal display device 1 according to the embodiment of the invention.

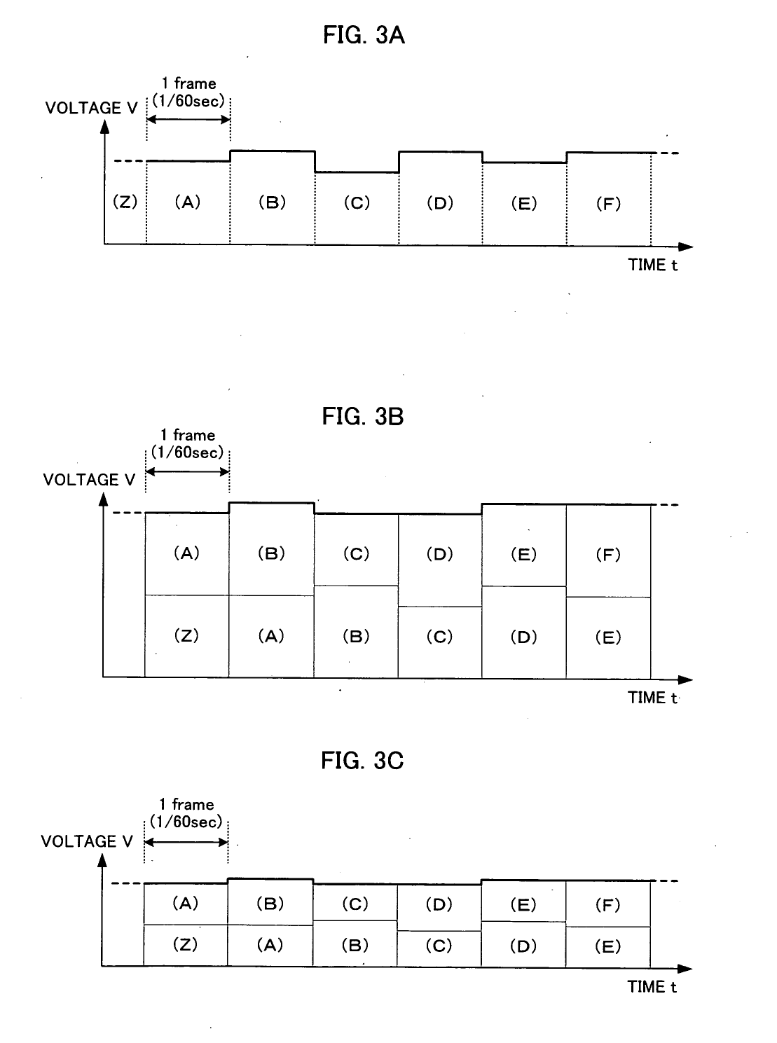

FIGS. 3A to 3C are respectively schematic diagrams showing the NR processing executed in the liquid crystal display device 1.

Since when the image corresponding to the video signal is judged to be a still image, the same image is contained in each of the frames in the video signal concerned, a constant video signal is assumed to be transmitted within a time period for which the still image is displayed. However, addition of the noise to the video signal concerned causes an error to occur in the video signal which should be originally constant, which results in that a flicker occurs in the still image.

FIG. 3A is a schematic diagram showing a situation in which the flicker occurs in the still image due to addition of the noise to the video signal. Although the still image ought to be essentially and usually displayed in each of the frames at a given voltage, the containing of the noise in the video signal to which the still image corresponding causes a change to occur in the voltage, which results in that the flicker occurs in the still image.

FIG. 3B is a schematic diagram showing a situation in which a sum of the voltages corresponding to the two continuous frames, i.e., the former frame and the latter frame, respectively, is obtained. The voltage corresponding to the latter frame is usually added to the voltage corresponding to the frame concerned corresponding to the currently transmitted image signal of the video signal. For example, a sum of the voltages corresponding to the frames (A) and (B) is obtained, a sum of the voltages corresponding to the frames (B) and (C) is obtained, and for forth. As a result, a state shown in FIG. 3B is obtained.

When the voltages of the video signals shown in FIG. 3B are added in adjacent two frames, it is about double that of an original video signal. Hence, the voltage of the video signal shown in FIG. 3B is halved, thereby obtaining a state shown in FIG. 3C in which a mean value of the added two voltages is obtained. As a result, the dispersion in voltage between the frames can be reduced and the flicker occurring in the still image can be reduced as compared with those in the state shown in FIG. 3A.

### [Overdrive Processing]

Next, a description will now be given with respect to overdrive (OD) processing executed in the liquid crystal display device 1 according to the embodiment of the invention.

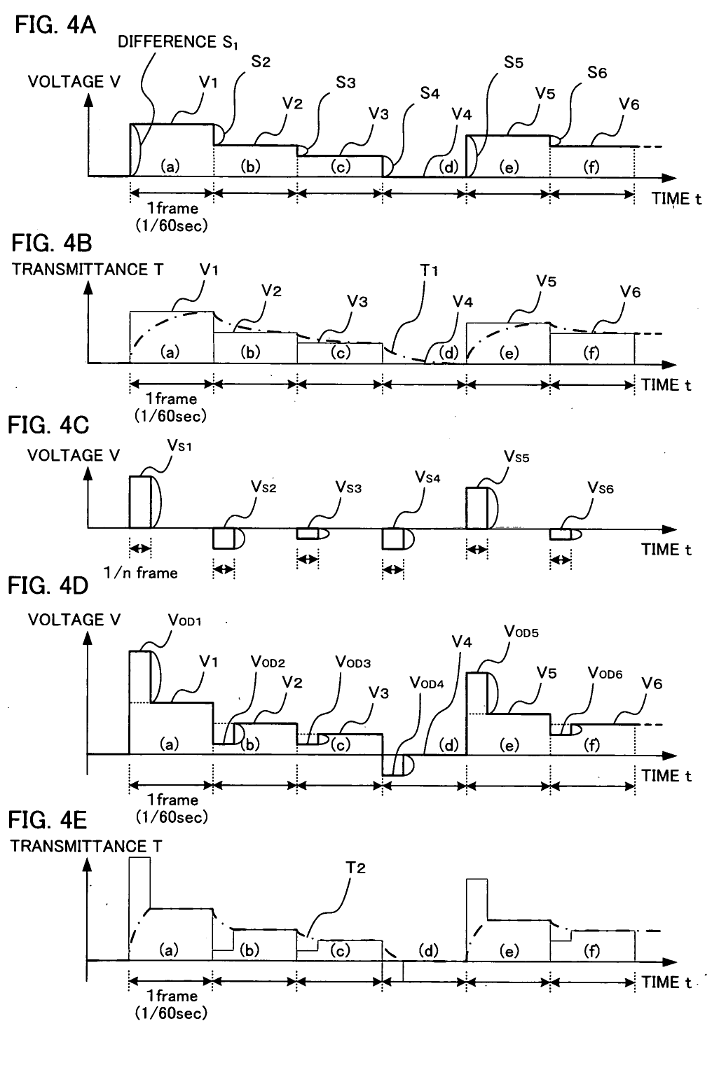

FIGS. 4A to 4E are respectively schematic diagrams showing the OD processing executed in the liquid crystal display device 1.

When the liquid crystal display device 1 receives the video signal to which the moving image corresponds, the voltage of the video signal usually changes in frames because the image corresponding to the video signal is the moving image. For example, as shown in FIG. 4A, the voltage of the video signal changes every frame (a), (b), (c), (d), (e), (f), etc. as represented by V₁, V₂, V₃, V₄, V₅, V₆, etc.

At this time, S₁, S₂, S₃, S₄, S₅, S₆, etc. each of which is a difference between a voltage in a selected frame and a voltage in the latter frame are obtained by obtaining differences between the former frames and the latter frames, respectively.

A transmittance of liquid crystal suitably corresponding to the applied voltage cannot be immediately obtained in the LCD panel 17 of the liquid crystal display device 1 because of the poor response as the shortcoming in property of the liquid crystal. Thus, an actual transmittance T₁ exhibits a dull change as indicated by a dashed line of FIG. 4B. Therefore, when this disadvantage is unsettled, the moving image blur inherent in the liquid crystal panel 17 becomes easy to occur.

In order to overcome such a situation, for the OD processing, firstly, differences S₁, S₂, S₃, S₄, S₅, S₆, etc. in voltage between the corresponding two continuous frames are calculated, respectively. Also, voltages having the respective differences are added to the voltages shown in FIG. 4A, respectively, for a given time period from each beginning of the respective one frame time periods. FIG. 4C shows a state in which voltages V_{S1}, V_{S2}, V_{S3}, V_{S4}, V_{S5}, V_{S6}, etc. having differences between the corresponding two continuous frames, respectively, in FIG. 4A are applied for 1/n of each frame time period from each beginning of the respective one frame time periods. In this embodiment, n is three or four.

Thus, the voltages shown in FIG. 4A and the voltages shown in FIG. 4C are applied to the LCD panel 17, and the sums of these voltages shown in FIGS. 4A and 4C are finally applied to the LCD panel 17. As a result, the voltages as shown in FIG. 4D are applied to the LCD panel 17. Therefore, the sums of the voltages V₁, V₂, V₃, V₄, V₅, V₆, etc. shown in FIG. 4A and the voltages V_{S1}, V_{S2}, V_{S3}, V_{S4}, V_{S5}, V_{S6}, etc. shown in FIG. 4C becomes voltages V_{OD1}, V_{OD2}, V_{OD3}, V_{OD4}, V_{OD5}, V_{OD6}, etc. shown in FIG. 4D.

The application of the voltages as shown in FIG. 4D to the LCD panel 17 results in that the response of the liquid crystal of the LCD panel 17 in each of the frames is quickened, and thus a transmittance T as shown in FIG. 4E is obtained. As a result, the response of the liquid crystal of the LCD panel 17 is improved and the moving image blur becomes hard to occur.

### [Operation for Image Processing]

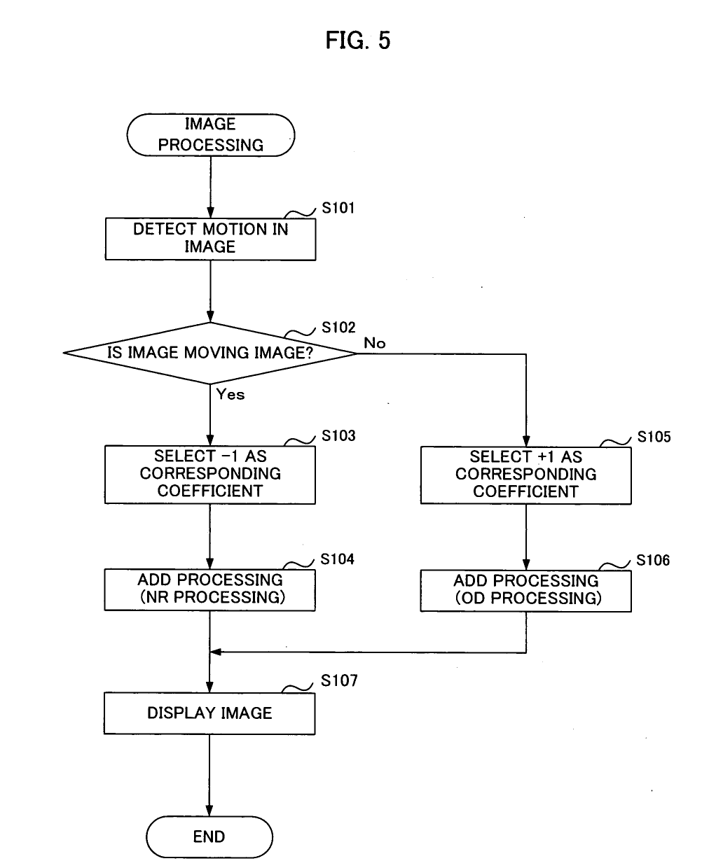

A situation of image processing executed in the liquid crystal display device 1 according to the embodiment of the invention will now be described with reference to a flow chart shown in FIG. 5.

FIG. 5 is a flow chart showing the image processing executed in the liquid crystal display device 1.

Firstly, when the video signal is inputted to the signal inputting circuit 11, the motion detecting circuit 12 detects a motion in the image corresponding to the inputted video signal (Step S101). Also, the motion detecting circuit 12 judges whether the image concerned is the moving image or the still image in accordance with its detection result (Step S102).

When the motion detecting circuit 12 judges that the image concerned is the moving image (S102: Yes), the coefficient selecting circuit 13 selects “−1” as the corresponding coefficient (Step S103). Also, the coefficient circuit 15 multiplies the image signal corresponding to the former frame, that is, the flame delayed by one by the coefficient, “−1”, and the add circuit 16 adds the resulting image signal to the image signal, inputted next time, corresponding to the latter frame, thereby obtaining a difference between the two continuous frames, that is, the former frame and the latter frame. Also, the resulting difference is added to the latter frame corresponding to the image signal inputted next time, thereby executing the OD processing (Step S104).

On the other hand, when the motion detecting circuit 12 judges that the image concerned is the still image (S102: No), the coefficient selecting circuit 13 selects “+1” as the corresponding coefficient (Step S105). Also, the coefficient circuit 15 multiplies the image signal corresponding to the former frame, that is, the frame delayed by one by the coefficient, “+1”, and the add circuit 16 adds the resulting image signal to the video signal, inputted next time, corresponding to the latter frame and halves the resulting video signal, thereby executing the NR processing (Step S106).

Also, the LCD panel 17 displays thereon the image corresponding to the resulting video signal (Step S107).

### Effects of Embodiment

According to the embodiment of the invention, the liquid crystal display device 1 includes the motion detecting circuit 12 and the coefficient selecting circuit 13, which results in that one circuit can execute simultaneously the NR processing and the OD processing, and thus it is possible to enhance the image qualities of both the still image and the moving image.

It should be noted that the present invention is not limited to the embodiments described above, and the various combinations and changes may be made without departing from or changing the technical idea of the present invention.

What is claimed is:

1. A liquid crystal display device, comprising:
a receiving portion for receiving a video signal;
a motion detecting portion for detecting whether an image corresponding to the video signal is a still image or a moving image; and
a signal adding portion for, when the motion detecting portion detects that the image is the still image, operating as a noise reduction circuit for the image, and when the motion detecting portion detects that the image is the moving image, operating as an overdrive circuit for the image.

2. A liquid crystal display device according to claim 1,
wherein the motion detecting portion detects whether the image corresponding to the video signal is the still image or the moving image by obtaining a difference between two continuous frames of the video signal.

3. A liquid crystal display device according to claim 1,
wherein the signal adding portion operates as the noise reduction circuit by adding the image signals corresponding to continuous frames contained in the image, and operates as the overdrive circuit by adding a difference between the image signals corresponding to continuous frames contained in the image to the image signal corresponding to the latter frame of the continuous frames.

4. A liquid crystal display device according to claim 2,
wherein the motion detecting portion includes a one frame-delaying circuit which delays a frame of the video signal by one frame period and a subtraction circuit which obtains the difference by subtracting the frame delayed in the one frame-delaying circuit from a latter frame of the video signal.

5. A liquid crystal display device according to claim 4,
wherein the motion detecting portion includes a difference-evaluating circuit which evaluates a signal output from the subtraction circuit.

6. A liquid crystal display device according to claim 3,
wherein the signal adding portion includes a first adding circuit which adds a video signal from the signal inputting circuit to a video signal from the coefficient circuit, a frame duration-dividing circuit which divides a duration of a signal output from the first adding circuit by a predetermined constant, a second adding circuit which adds a signal output from the frame duration-dividing circuit to a video signal from the signal inputting circuit, and a mean voltage value-calculating circuit which obtains a mean voltage value of the signal output from the frame duration-dividing circuit and a video signal from the signal inputting circuit by dividing a signal from the second adding circuit by 2.

7. A liquid crystal display device, comprising:
a receiving portion for receiving a video signal;
a motion detecting portion for detecting whether an image corresponding to the video signal is a still image or a moving image; and
a signal adding portion for, when the motion detecting portion detects that the image is the still image, adding image signals corresponding to continuous frames contained in the image, and when the motion detecting portion detects that the image is the moving image, adding a difference between image signals corresponding to the continuous frames contained in the image to the video signal corresponding to the latter frame of the continuous frames.

8. A liquid crystal display device according to claim 7,
wherein the motion detecting portion detects whether the image corresponding to the video signal is the still image or the moving image by obtaining a difference between two-continuous frames of the video signal.

9. A liquid crystal display device according to claim 7,
wherein the signal adding portion, when the motion detecting portion detects that the image is the still image, adds the image signals corresponding to continuous frames contained in the image, calculates a mean value of the added image signals, and outputs the resulting mean value.

10. A liquid crystal display device according to claim 7,
wherein the signal adding portion, when the motion detecting portion detects that the image is the moving image, calculates a difference between the image signals corresponding to continuous frames contained in the image, and adds a signal obtained by dividing a duration of the difference by a predetermined constant to the image signal corresponding to the latter frame of the continuous frames as its start.

11. A liquid crystal display device according to claim 8,
wherein the motion detecting portion includes a one frame-delaying circuit which delays a frame of the video signal by one frame period and a subtraction circuit which obtains the difference by subtracting the frame delayed in the one frame-delaying circuit from a latter frame of the video signal.

12. A liquid crystal display device according to claim 11,
wherein the motion detecting portion includes a difference-evaluating circuit which evaluates a signal output from the subtraction circuit.

13. A liquid crystal display device according to claim 9,
wherein the signal adding portion includes a first adding circuit which adds a video signal from the signal inputting circuit to a video signal from the coefficient circuit, and a mean voltage value-calculating circuit which obtains a mean voltage value of the signal output from the first adding circuit and a video signal from the signal inputting circuit by dividing a signal from the second adding circuit by 2.

14. A liquid crystal display device according to claim 10, wherein the signal adding portion includes a first adding circuit which adds a video signal from the signal inputting circuit to a video signal from the coefficient circuit, a frame duration-dividing circuit which divides duration of a signal output from the first adding circuit by a predetermined constant, a second adding circuit which adds a signal output from the frame duration-dividing circuit to a video signal from the signal inputting circuit.

15. A liquid crystal display device, comprising:
a receiving portion for receiving a video signal;
a motion detecting portion for detecting whether an image corresponding to the video signal is a still image or a moving image;
a coefficient selecting portion for, when the motion detecting portion detects that the image is the still image, selecting a positive coefficient, and when the motion detecting portion detects that the image is the moving image, selecting a negative coefficient;
a coefficient multiplying portion for multiplying a former image signal of the image signals corresponding to continuous frames contained in the image by the positive or negative coefficient selected by the coefficient selecting portion; and
a signal adding portion for adding an image signal obtained from the coefficient selecting portion to the former image signal of the image signals corresponding to the continuous frames contained in the image.

16. A liquid crystal display device according to claim 15,
wherein the motion detecting portion detects whether the image corresponding to the video signal is the still image or the moving image by obtaining a difference between two continuous frames of the video signal.

17. A liquid crystal display device according to claim 15,
wherein the signal adding portion, when the motion detecting portion detects that the image is the still image, adds the image signals corresponding to the continuous frames contained in the image, calculates a mean value of the added image signals, and outputs the resulting mean value.

18. A liquid crystal display device according to claim 15,
wherein the signal adding portion subtracts image signals of the continuous frames to provide a difference, divides a duration period of the difference by a predetermined constant to provide a divided signal, and adds the divided signal to a predetermined beginning period of an image signal of a latter frame of the continuous frames, when the motion detecting portion detects the image to be the moving image.

19. A liquid crystal display device according to claim 16,
wherein the motion detecting portion includes a one frame-delaying circuit which delays a frame of the video signal by one frame period and a subtraction circuit which obtains the difference by subtracting the frame delayed in the one frame-delaying circuit from a latter frame of the video signal.

20. A liquid crystal display device according to claim 19,
wherein the motion detecting portion includes a difference-evaluating circuit which evaluates a signal output from the subtraction circuit.
